(19) United States
(12) Patent Application Publication
(10) Pub. No.: US 2011/0058100 A1
(43) Pub. Date: Mar. 10, 2011

(54) VIDEO SIGNAL PROCESSING APPARATUS AND VIDEO SIGNAL PROCESSING METHOD

(76) Inventor: Yasuhiko Muto, Fukaya-shi (JP)

(21) Appl. No.: 12/718,534

(22) Filed: Mar. 5, 2010

(30) Foreign Application Priority Data
Sep. 9, 2009 (JP) 2009-208685

(51) Int. Cl. H04N 7/01

(52) U.S. Cl. 348/445; 348/E07.003

(57) ABSTRACT

A video signal processing apparatus includes: a receiver receiving input of a predetermined video display mode; a video converter generating video data by sampling a video signal with a predetermined resolution inputted from the outside at an arbitrary sampling frequency and scaling the area corresponding to an enlargement scaling factor of the generated video data at an arbitrary enlargement ratio; and a controller controlling, when the input of the predetermined video display mode is received by the receiver, the sampling frequency and the enlargement ratio of scaling to enlarge the area in the video data having almost the same aspect ratio as an aspect ratio of a display panel at a rate of an integral multiple or n/2-times (n is an integer).

### CROSS-REFERENCE TO THE INVENTION

This application is based upon and claims the benefit of priority from the prior Japanese Patent Application No. 2009-208685, filed on Sep. 9, 2009; the entire contents of which are incorporated herein by reference.

### BACKGROUND OF THE INVENTION

1. Field of the Invention

The present invention relates to a video signal processing apparatus and a video signal processing method for example.

2. Description of the Related Art

With the start of terrestrial digital broadcast, there are commercialized many television apparatuses (hereinafter, referred to as “HDTV”) having large-sized screen liquid crystal flat panels (hereinafter, referred to as “full HD panel”) capable of full specification high definition display.

The HDTV has an external video signal input terminal such as an HDMI terminal and a D terminal, and input of a game video of a portable video game player to the D terminal for example enables display of the game video in a large-sized screen so that the game can be enjoyed.

Meanwhile, a resolution of a game video outputted by a portable video game player is a resolution (480×272 pixels) for example, and a resolution of a D terminal is 480 P (720×480 progressive).

Therefore, the HDTV obtains a video (hereinafter, referred to as “D2 original image”) of 720×480 pixels (aspect ratio 3:2) having a black area surrounding the game video.

It should be noted that this black area is generated by a black signal outputted by the portable video game player.

If the D2 original image is simply displayed dot by dot, a game video of a small-sized screen having a black frame is set in a full HD panel, and a scaling processing such as enlargement is generally performed.

However, since the D2 original image (aspect ratio 3:2) of an input origin and the full HD panel (aspect ratio 16:9) have different aspect ratios, simply enlarged display of lateral and longitudinal pixels deteriorates a circularity ratio, flattening the video and generating a sense of incompatibility in viewing.

As a technology for displaying while maintaining a circularity ratio in a case that an aspect ratio of a video of an input origin and an aspect ratio of a display panel are different as above, there is disclosed a video signal processing apparatus enabling display of a high-quality video even when a resolution of an input video and a resolution of a display apparatus are different by setting a sampling frequency of a digital video signal to have a sampling number which does not require digital data to be scaled in a horizontal direction in accordance with a horizontal resolution of the display apparatus for example (see JP-A 2006-227442 (KOKAI) for example).

### BRIEF SUMMARY OF THE INVENTION

However, in a case of the above-described conventional technology, though the technology about aspect ratios of 4:3 to 16:9 and 16:9 to 4:3 are described, a technology for enlargedly displaying a peculiar video of a portable video game player inputted to a D terminal is not described, and there is a problem that such a video cannot be enlargedly displayed with a circularity ratio being maintained.

The present invention is made to solve such a problem and its object is to provide a video signal processing apparatus and a video signal processing method in which a video inputted to an external video signal input terminal is enlargedly displayed with a circularity ratio being maintained and a high-quality video without image degradation can be displayed.

A video signal processing apparatus according to an aspect of the present invention includes: a receiver configured to receive input of a predetermined video display mode; a video converter configured to generate video data by sampling a video signal with a predetermined resolution inputted from the outside at an arbitrary sampling frequency and scaling the area corresponding to an enlargement scaling factor of the generated video data at an arbitrary enlargement ratio; and a controller configured to control, when the input of the predetermined video display mode is received by the receiver, the sampling frequency and the enlargement ratio of scaling to enlarge the area in the video data having almost the same aspect ratio as an aspect ratio of a display panel at a rate of an integral multiple or n/2-times (n is an integer).

A video signal processing method according to an aspect of the present invention includes: receiving input of a predetermined video display mode; controlling, when the input of the predetermined video display mode is received, a sampling frequency and an enlargement ratio of scaling to enlarge the area corresponding to an enlargement scaling factor in video data having almost the same aspect ratio as an aspect ratio of a display panel at a rate of an integral multiple or n/2-times (n is an integer) and generating video data by sampling a video signal with a predetermined resolution inputted from the outside at the controlled sampling frequency and scaling the area of the generated video data at the controlled enlargement ratio.

According to the present invention, it is possible to enlargedly display a video inputted to an external video signal input terminal while maintaining a circularity ratio and to display a high-quality video without image degradation.

### BRIEF DESCRIPTION OF THE DRAWINGS

FIG. 1 is a diagram showing a constitution of a video signal processing apparatus of an embodiment of the present invention.

FIG. 2 is a diagram showing an example of a video menu.

FIG. 3 is a diagram showing an example of a game screen menu.

FIG. 4 is a diagram showing a D2 original image.

FIG. 5 is a diagram showing a display example of a video of a portable video game player enlarged to four times (4×).

FIG. 6 is a diagram showing a display example of a video of a portable video game player enlarged to three times (3×).

### DETAILED DESCRIPTION OF THE INVENTION

Hereinafter, a television apparatus of an embodiment according to a video signal processing apparatus of the present invention will be described in detail with reference to the drawings.

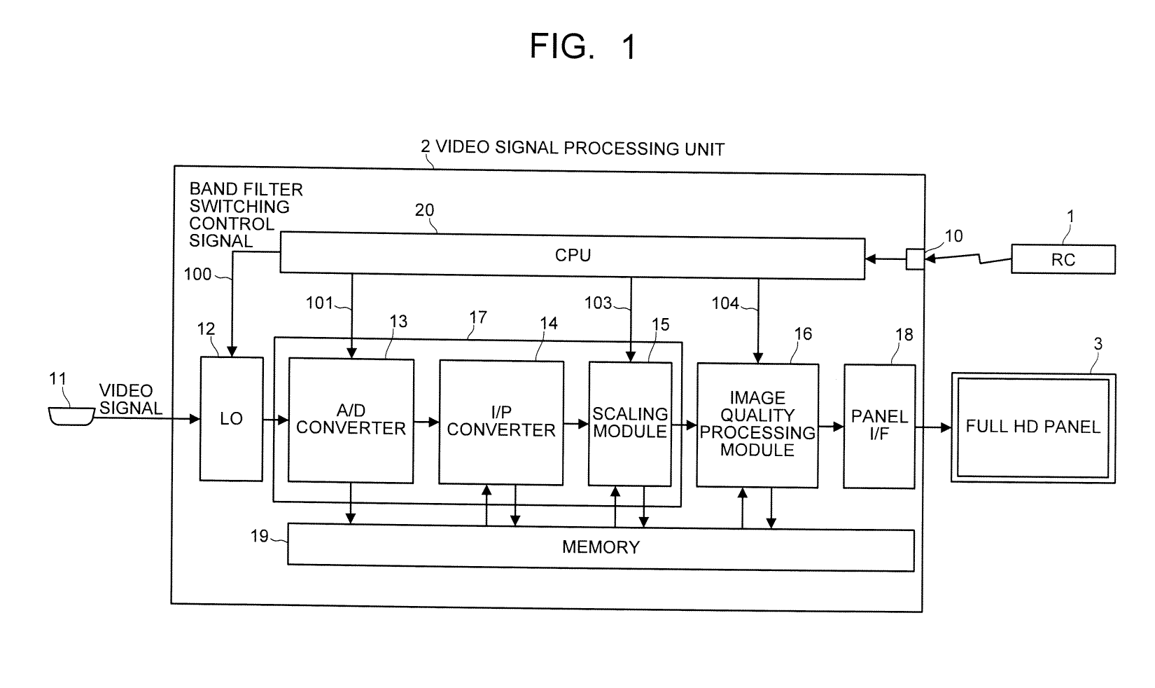

FIG. 1 is a diagram showing a constitution of the television apparatus.

As shown in FIG. 1, the television apparatus of this embodiment has a remote controller 1 (hereinafter, referred to as “RC 1”) as a manipulation unit, a video signal processing unit 2, and a large-sized screen liquid crystal flat panel 3 (hereinafter, referred to as “full HD panel 3”) capable of full specification high vision display.

The manipulation unit can be a button provided in a TV main body other than the RC 1.

The full HD panel 3 has a screen of a full HD size (1920×1080 pixels) (aspect ratio 16:9).

This screen has a resolution of at least twice the number of vertical-direction lines of an input image of a D terminal of 720×480 pixels (aspect ratio 3:2), and can draw a video with an arbitrarily designated number of horizontal and vertical display pixels.

This screen can draw the video with the arbitrarily designated number of horizontal and vertical display pixels.

The video outputted from the video signal processing unit 2 is displayed in the screen of the full HD panel 3.

In this screen, the video outputted from the video signal processing unit 2 is displayed.

The RC 1 is connected to the video signal processing unit 2 by radio communication such as infrared communication.

Multiple buttons for manipulating functions housed in the television apparatus are provided in the RC 1.

A command is issued from an infrared transmitter (not shown) of the RC 1 by manipulation of the desired button.

A CPU 20 accepts this command via an infrared receiver 10 of the video signal processing unit 2 and performs a processing corresponding to the command.

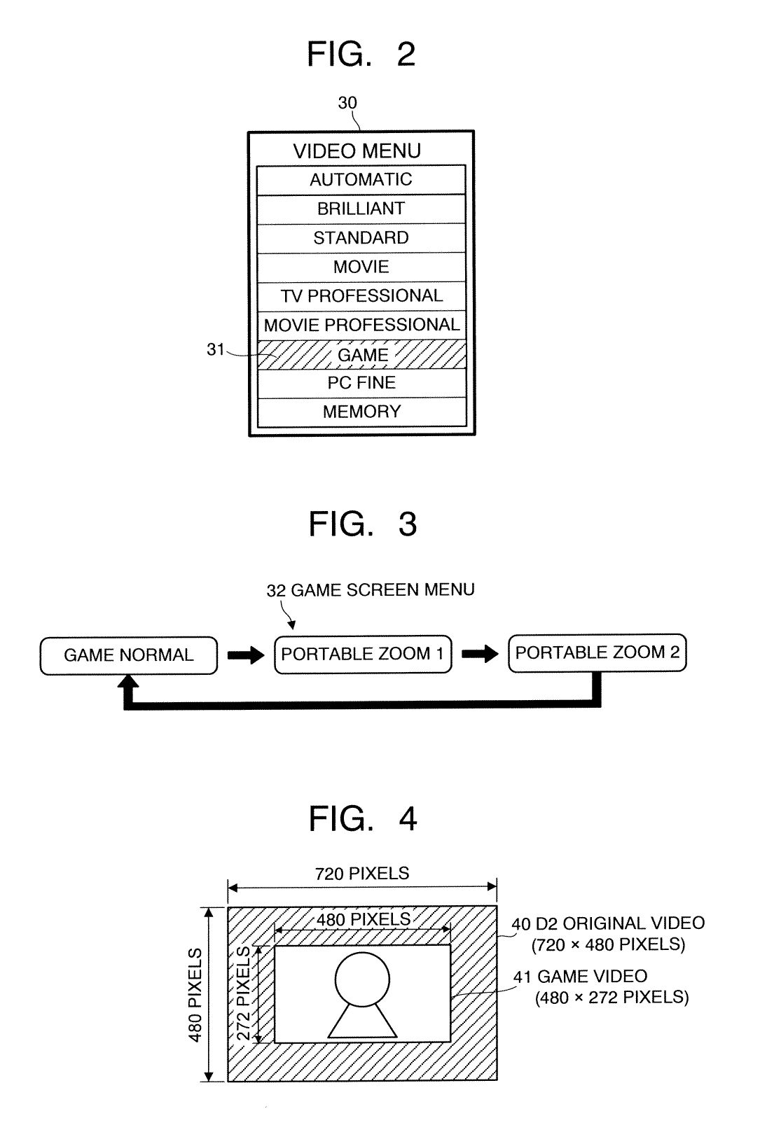

By button manipulation of a video menu of the RC 1 for example, as shown in FIG. 2, the CPU 20 displays a video menu 30 in which setting items are longitudinally laid out in the screen of the full HD panel 3.

As the setting items of the video menu 30, there are, for example, “automatic”, “brilliant”, “standard”, “movie”, “TV professional”, “movie professional”, “game”, “PC fine”, “memory” and so on.

When a viewer designates the setting item such as “game” 31 in the video menu with the RC 1, the CPU 20 stores “game mode” as an operation mode in a memory 19, and performs screen control in “game mode”.

Viewer's manipulation of the button of a game screen menu of the RC 1 during this “game mode” makes the CPU 20 display a game screen menu 32 shown in FIG. 3.

Three screen setting items such as “game normal”, “portable zoom 1”, “portable zoom 2” are cyclically displayed in the game screen menu 32.

Every time a user manipulates the button for designating the item in the RC 1, the item of the screen setting changes to the next item, so that a desired screen can be set.

In other words, the game screen menu 32 is a screen setting menu dedicated to games, for designating an angle of view (size of the game screen) of a game video in “game mode”.

The game screen menu 32 shown here is only an example and other examples can be thought of.

The item “game normal” is a setting to display a video (hereinafter referred to as “D2 video”) inputted to a D terminal 11 almost without modification.

The D2 video is a video of 720×480 pixels (aspect ratio 3:2).

A video of a portable game player is of 272×480 pixels (aspect ratio 16:9).

As shown in FIG. 4, the D2 video is a video in a state that a video 41 of the portable video game player is pasted in a center and the area of a difference is filled with black pixels. This is called a D2 original image.

The item “portable zoom 1” is a setting to enlargedly display each of a lateral size and a longitudinal size of the portable video game player video to three times (3×).

The item “portable zoom 2” is a setting to enlargedly display each of the lateral size and the longitudinal size of the portable video game player video to four times (4×).

In this menu, though items of three screen settings are cyclically repeated, the setting items can be longitudinally laid out so that the setting item can be selected by button manipulation in a longitudinal direction, similarly to in the video menu 30 shown in FIG. 2 above.

The video signal processing unit 2 has the infrared receiver 10, the D terminal 11, a low pass filter (LO) 12, an analog/digital converter 13 (hereinafter, referred to as “A/D converter 13”), an I/P converter 14, a scaling module 15, an image quality processing module 16, a video converter 17, a panel I/F 18, a memory 19, the CPU 20 and so on.

The infrared receiver 10 receives the command of button manipulation issued from the RC 1 and transmits to the CPU 20.

The D terminal 11 is a video signal input terminal into which analog component terminals are united and through which a type (number of scan lines, frame rate, I/P information (information of interlace signal/progressive signal), aspect ratio, and the like) of the video can be transmitted from a control line, as format information of the video.

A D terminal cable from the portable video game player for example is connected to the D terminal 11 and an analog video signal of a resolution of 480 P (720×480 progressive) is inputted thereto. Hereinafter, this video signal is referred to as a D2 original video 40.

The low pass filter (LO) 12 is a band filter filtering off an unnecessary band at a time of sampling data from the analog video signal (D2 original video 40) inputted from the D terminal 11.

In other words, the low pass filter (LO) 12 passes a frequency band necessary for sampling a video according to Nyquist theorem.

The A/D converter 13 samples the video signal of the band having been passed by the low pass filter (LO) 12 with a sampling frequency designated by the CPU 20, converts the video signal into digital video data, and stores in the memory 19.

In this example, in “game normal”, “portable zoom 1”, and “portable zoom 2”, video signals are sampled at 27 MHz (one time; 1×) and converted into digital video data.

In other words, the A/D converter 13 samples an analog video signal of a predetermined resolution inputted from the outside with a designated sampling frequency, thereby generating digital video data.

The I/P converter 14, by a control signal 102 from the CPU 20, reads the digital video data stored in the memory 19, and converts an I (interlace) signal into a P (progressive) signal.

In a case of a game video, since an original video signal is a progressive signal, I/P conversion is not performed in this example.

The scaling module 15, by designation of a scaling factor by a control signal 103, reads the progressive video via the I/P converter 14 from the memory 19 and performs a scaling processing, that is, controls a scaling factor of enlargement or reduction of the video or controls filtering such as edge correction by a scaling filter, and stores in the memory 19.

In the game mode, since the screen of the full HD panel 3 is large in relation to the D2 original video 40, the video is controlled to be enlarged.

Information of the area corresponding to an enlargement scaling factor is set in the scaling module 15 in advance, and by a designation of a scaling factor from the CPU 20, the area corresponding to the enlargement scaling factor is enlarged.

For example, it is set to enlarge the area of 480×270 pixels in a case of four times (4×) and to enlarge the area of 640×360 pixels in a case of three times (3×).

The image quality processing module 16, by a designation by a control signal 104, reads the scaled video from the memory 19 and adjusts an image quality, that is, performs a gamma correction, an image quality correction and the like of the video and outputs to the panel I/F 18.

The panel I/F 18 is an interface drawing (outputting) the video via the image quality processing module 16 in the screen of the full HD panel 3, and converts the video into a signal format compliant to a panel standard.

A video converter 17 includes the A/D converter 13, the I/P converter 14 and the scaling module 15, and sets the sampling frequency and controls I/P conversion as well as the enlargement ratio of the video by the designations by the control signals 101, 102, 103, thereby enlarging a part of the area of the D2 original video 40 to three times (3×) or four times (4×), and stores in the memory 19.

In other words, the video converter 17 samples an analog video signal (video signal from the portable video game player) with a predetermined resolution inputted from the outside in a horizontal direction and a vertical direction at a sampling frequency controlled by the CPU 20, thereby generating digital video data, and scales the generated video data at an enlargement ratio controlled by the CPU 20.

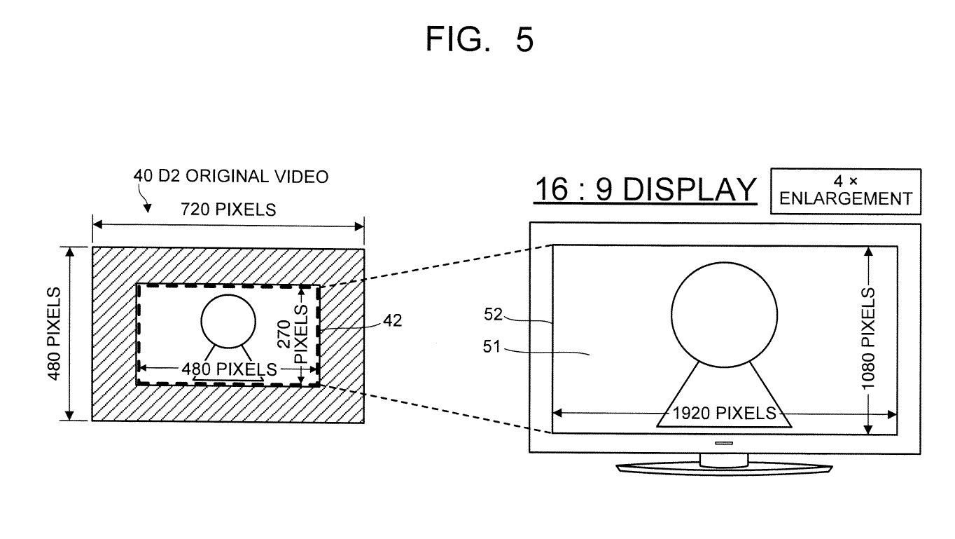

For example, when “portable zoom 2” is set in “game mode”, a portion ((480×270 pixels) this is referred to as “game video frame”) of almost the same range as that of a game video 41 (480×272 pixels) in a central portion of the D2 original video 40 is enlarged to four times (4×) (at a rate of an integral multiple) (see FIG. 5).

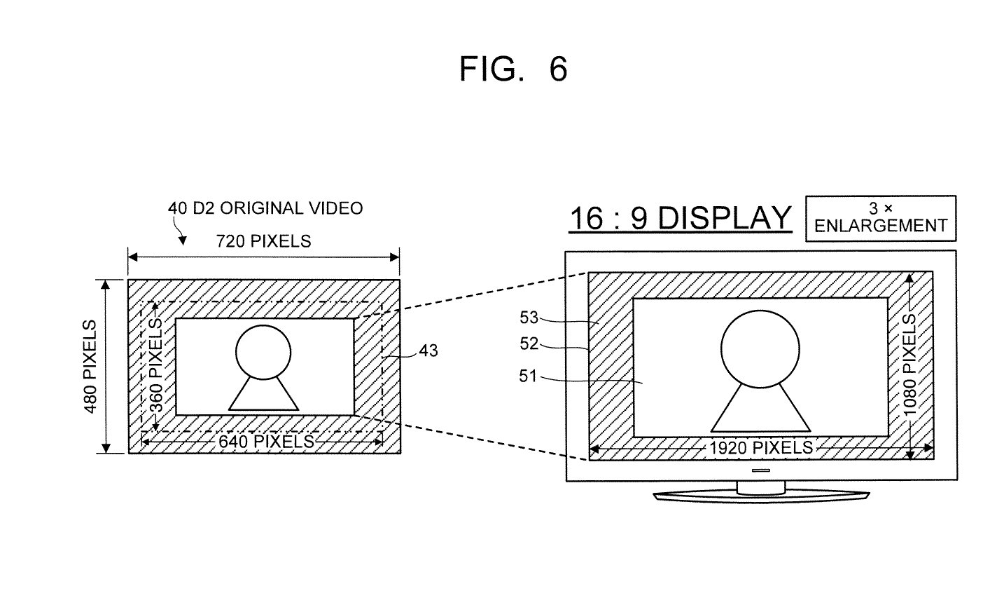

Meanwhile, when “portable zoom 1” is set in “game mode”, a portion (game video 43 with a black frame) of the area (640×360 pixels) including the game video 41 in the central portion of the D2 original video 40 and a part of a black pixel area is enlarged to three times (3×) (at a rate of an integral multiple) (see FIG. 6).

It should be noted that aspect ratios in both cases of three times (3×) and four times (4×) enlargement are almost 16:9.

The memory 19 is a dynamic RAM or the like and is a temporary storage place of the video data being processed.

Further, the memory 19 functions as a working area in which the CPU 20 processes data.

The CPU 20 functions as a receiver receiving input of a predetermined video display mode (in a case that “portable zoom 2” is selected and inputted in the setting of “game mode” or in a case that “portable zoom 1” is selected and inputted in the setting of “game mode”).

Further, the CPU 20 outputs the control signals 101, 102, 103, 104 to the above-described respective modules and performs control for drawing the video in the screen of the full HD panel 3.

More specifically, when the operation mode is “game mode” and “portable zoom 2” is designated in the game screen menu for example, the CPU 20 controls the respective modules as below.

To the A/D converter 13, the CPU 20 outputs the control signal 101 to set a frequency of a sampling clock in a horizontal valid period at 27 MHz (one time; 1×), to import 720 pixels of horizontal valid pixels and to import 480 lines (one time; 1×) with regard to the vertical direction.

To the scaling module 15, the CPU 20 outputs the control signal 103 to enlarge the game video frame of the game video 41 imported in the memory 19 to four times (4×), and not to turn on the scaling filter when the enlargement ratio is integral multiple, that it not to perform filtering such as edge correction either in the horizontal or the vertical direction.

If the operation mode is “game mode” and “portable zoom 1” is inputted in the game screen menu for example, the CPU 20 controls the respective modules as below.

To the A/D converter 13, the CPU 20 outputs the control signal 101 to set the frequency of the sampling clock in the horizontal valid period at 27 MHz (one time; 1×), to import 720 pixels of horizontal valid pixels and to import 480 lines (one time; 1×) with regard to the vertical direction.

To the scaling module 15, the CPU 20 outputs the control signal 103 to enlarge the area (see FIG. 5) of the game video 43 with the black frame imported in the memory 19 to three times (3×), and not to perform filtering in the horizontal direction or in the vertical direction when the enlargement ratio is integral multiple or n/2-times (n is an integer).

Further, to the image quality processing module 16, the CPU 20 outputs the control signal 104 to perform image quality adjustment (gamma correction, image quality correction and the like) as usual.

In other words, when the input of the predetermined video display mode (“game mode” and “portable zoom 1” or “game mode” and “portable zoom 2”) is received, the CPU 20 controls the sampling frequency of the video converter 17 and the enlargement ratio of scaling to enlarge the area corresponding to an enlargement scaling factor in the video data (D2 original video 40), the area having almost the same aspect ratio (16:9) as that of the full HD panel 3, at a rate of an integral multiple or n/2-times (n is an integer).

It should be noted that the area corresponding to the enlargement scaling factor means the area 42 of FIG. 5 when the enlargement scaling factor is four times (4×) for example, and the area 43 of FIG. 6 when the enlargement scaling factor is three times (3×).

Subsequently, an operation of this television apparatus will be described with reference to FIG. 5 and FIG. 6.

In this television apparatus, when a game video (for example 480 P) is inputted to the D terminal 11, A/D conversion is performed after band filtering.

Thereafter, the video to which scaling and image quality adjustment are performed is displayed in the full HD panel 3.

Conventionally, when a control signal 101 is inputted from a CPU 20 to an A/D converter 13, the A/D converter 13 sets a sampling clock at 27 MHz and samples data from an input video, so that a D2 original video 40 is imported in a memory 19 at an angle of view of 720×480 pixels (aspect ratio 3:2).

When a screen size of a display panel is of full HD size (1920×1080 pixels) (aspect ratio 16:9), in dot-by-dot display at 720×480 pixels (aspect ratio 3:2), a display size of a game video in relation to a screen size of a display panel is quite small, and in addition, the aspect ratio of 3:2 of the game video is different from the aspect ratio of 16:9 of the display panel, and consequently a circularity ratio of the game video is deteriorated.

Thus, usually, in order that image conversion is always performed both horizontally and vertically to video data imported into the memory 19, the CPU 20 outputs control signals 103, 104 to a scaling module 15 and an image quality processing module 16, thereby performing scaling and filtering uniformly to the video data.

Thereafter, a predetermined image quality processing is performed in an image quality processing module 16 and the video data is outputted to a full HD panel 3, and consequently the game video inputted to the full HD panel 3 is enlargedly displayed, but image blurring occurs.

Thus, in this embodiment, a display setting dedicated to games such as “portable zoom 1” and “portable zoom 2” described below is prepared.

First, a display operation of “portable zoom 2” will be described with reference to FIG. 5.

When the operation mode of the screen control is set to “game mode” in the video menu (see FIG. 2) and “portable zoom 2” is set (designated) in the game screen menu (see FIG. 3), the CPU 20 outputs a control signal 101 to the A/D converter 13 to set a frequency of a sampling clock in a horizontal direction at 27 MHz and to import 480 lines with the number thereof unchanged with regard to a vertical direction.

Further, the CPU 20 outputs a control signal 103 to the scaling module 15 to perform scaling (enlargement control) of the video at an enlargement ratio of four times (4×) laterally and longitudinally and not to perform filtering (not to turn on the scaling filter) when the enlargement ratio is an integral multiple.

As a result of this control, the A/D converter 13 sets a frequency of a sampling clock in a horizontal valid period to 27 MHz and performs sampling of 720 times in a horizontal valid period of 26.66 μs.

Thereby, a horizontal valid pixel is sampled at 720 pixels and, with regard to a vertical direction, sampling at 480 lines is performed.

The sampled D2 original video 40 is, as shown in FIG. 4, a video of 720×480 pixels formed by surrounding a periphery of the game video of 480×272 pixels with black pixels.

In other words, the D2 original video 40 is a video of 720×480 pixels in which the game video (480×272 pixels) is pasted in a central portion.

Then, the scaling module 15 scaling (enlargement) processes a portion of the game video frame 42 (480×270 pixels) in the D2 original video 40 to four times (1920×1080 pixels) both laterally and longitudinally, and stores in the memory 19.

The image quality processing module 16 performs an image quality processing set in advance such as a gamma correction and an image quality correction.

The panel I/F 18 outputs the game video which has been image-quality processed by the image quality processing module 16 to the full HD panel 3.

As a result, as shown in FIG. 5, a game video 51 of 1920×1080 pixels is displayed in a display screen 52 of the full HD panel 3.

On this occasion, the clipped game video frame 42 is of 480×270 pixels in relation to the game video (480×272 pixels), lacking pixels in the longitudinal direction by one in each of upper and lower directions, and when the game video is enlargedly displayed in the full HD panel, a portion of the video equivalent to one pixel is cut.

However, usually, in games, upper and lower edge portions of a video are not used, and the above is effective when it is desired to enlarge a game video as largely as possible for viewing.

Next, a display operation of “portable zoom 1” will be described with reference to FIG. 6.

When the operation mode of the screen control is set to “game mode” in the video menu (see FIG. 2) and “portable zoom 1” is set (designated) in the game screen menu (see FIG. 3), the CPU 20 outputs a control signal 101 to the A/D converter 13 to set a frequency of the sampling clock at 27 MHz.

Further, the CPU 20 outputs a control signal 103 to the scaling module 15 to perform scaling of the area 43 (hereinafter referred to as “game video 43 with a black frame”) of a black frame of 640×360 pixels in the central portion of the D2 original video 40 to three times (3×) both laterally and longitudinally.

By the input of the control signal 101, the A/D converter 13 performs sampling, and the D2 original video 40 shown in FIG. 4 is obtained.

The processings above are the same as those in the case of four times (4×) enlargement.

The scaling module 15 performs a scaling (enlargement) processing to the game video 43 (640×360 pixels) with a black frame in which the game video (480×272 pixels) of the D2 original video 40 is included, thereby making the area 43 with a black frame be three times (3×) both laterally and longitudinally to be of a full HD size (1920×1080 pixels), and stores in the memory 19.

Then, the image quality processing module 16 performs a predetermined image quality processing such as a gamma correction and an image quality correction and outputs to the panel I/F 18.

The panel I/F 18 converts the game video 43 with a black frame which has been inputted from the image quality processing module 16 into a signal format compliant with a panel standard and outputs to the full HD panel 3.

As a result, as shown in FIG. 6, there is a black pixel area 53 in the screen 52 of the full HD panel 3 and the game video 51 is displayed in a central portion thereof.

An angle of view of the game video 51 at three times (3×) enlargement becomes 1440×816 pixels (aspect ratio 16:9), and in this case the circularity ratio is also maintained.

In this example of three times (3×) enlargement, there is an effect that, in a case that a full HD panel 3 is a large-sized screen of 52 inches or more for example and a viewer is too close to a screen for playing a game, a game screen can be displayed at an appropriate size and a game video becomes easy to be viewed.

As described above, according to the television apparatus of this embodiment, when the operation mode of the screen control is set to “game mode” and “portable zoom 2” is designated in the game screen menu, the A/D converter 13 imports the video signal from the D terminal at a ratio of one time (1×) and the scaling module 15 enlarges the portion of the game video screen 42 (480×270 pixels) among the imported D2 original video 40 to four times (4×).

Further, when the operation mode of the screen control is set to “game mode” and “portable zoom 1” is designated in the game screen menu, the A/D converter 13 imports the video signal from the D terminal 11 at a rate of one time (1×) and the scaling module 15 enlarges the portion of the game video 43 (640×360 pixels) with a black frame among the imported D2 original video 40 to three times (3×).

Thereby, it is possible to enlargedly display a game video in a full HD panel 3 without deteriorating an aspect ratio of a D2 original video inputted from a portable video game player to a D terminal 11.

Further, since video data is enlarged at a rate of an integral multiple or n/2-times (n is an integer), image quality is not degraded, thereby it is possible to display a realistic game video created by a game creator.

In other words, it is possible to display a game video while maintaining an original aspect ratio (lateral/longitudinal ratio) of 16:9 and a circularity ratio of a video (480×272 pixels) of a portable video game player.

Further, since an image quality processing is not performed to a game video, contour portions of the video can be displayed clearly.

In other words, by performing enlarged display while maintaining a circularity ratio of a video of a portable video game player inputted to a D terminal 11 and displaying a high quality game video without image quality deterioration in a full HD panel 3, a viewer can enjoy a realistic game video with texture of dots.

It should be noted that the present invention is not limited to the above-described embodiment but a component can be modified in a practical phase without departing from the range of the gist of the present invention.

In the above-described embodiment, three modes of “game normal”, “portable zoom 1”, and “portable zoom 2” are provided, but it suffices that only either one of “portable zoom 1” and “portable zoom 2” is provided.

In the above-described embodiment there is described an example in which in a case of display of four times (4×) the A/D converter 13 imports the video data to one time (1×) and the scaling module 15 enlarges the imported video data to four times (4×), but other than the above the following combinations are possible.

For example, the A/D converter 13 imports the video data to two times (2×) and the scaling module 15 enlarges the imported video data to two times (2×), or the A/D converter 13 imports the video data to four times (4×) and scaling is not performed to the imported video data having been imported to four times (4×) (video data is not enlarged).

Further, in the above-described embodiment there is described an example in which in a case of display of three times (3×) the A/D converter 13 imports the video data at a rate of one time (1×) and the scaling module 15 enlarges the imported video data to three times (3×), but other than the above the following combinations are possible.

For example, the A/D converter 13 imports the video data to two times (2×) and the scaling module 15 enlarges the imported video data to one and a half times, or the A/D converter 13 imports the video data to three times (3×) and scaling is not performed to the imported video data (video data is not enlarged).

As describe above, various combinations of scaling factors of the A/D conversion and scaling are possible.

It should be noted that in enlarging a horizontal resolution, heightening a sampling frequency of A/D conversion by a designation by a control signal 101 and lowering an enlargement ratio of scaling by a designation by a control signal 103 restrain degradation of an image quality in scaling, so that an image quality of a game video can be improved.

Further, it is possible to realize each component described in the above-described embodiment by a program installed in a storage such as a hard disk device of a computer.

Further, it is possible to make a computer realize a function of the present invention by storing the above-described program in a computer-readable electronic medium and making the computer read the program from the electronic medium.

As an electronic medium, for example, storage medium such as a CD-ROM, flash memory, removable medium and the like are included.

Further, it is possible to realize the function of the present invention by storing the components dispersedly in different computers connected via a network and communicating among computers in which the respective components are functioned.

### Other Embodiments

By properly combining a plurality of components disclosed in the above-described embodiment, various inventions can be constituted. For example, some components can be deleted from the entire components shown in the embodiment.

In other words, the embodiment of the present invention is not limited to the above-described embodiment and can be expanded and modified, and the expanded or modified embodiment is included in the technical range of the present invention.

What is claimed is:

1. A video signal processing apparatus, comprising:
a receiver configured to receive input of a predetermined video display mode;
a video converter configured to generate video data by sampling a video signal with a predetermined resolution inputted from the outside at an arbitrary sampling frequency and scaling the area corresponding to an enlargement scaling factor of the generated video data at an arbitrary enlargement ratio; and
a controller configured to control, when the input of the predetermined video display mode is received by the receiver, the sampling frequency and the enlargement ratio of scaling to enlarge the area in the video data having almost the same aspect ratio as an aspect ratio of a display panel at a rate of an integral multiple or n/2-times (n is an integer).

2. The video signal processing apparatus of claim 1,
wherein the predetermined video display mode is a game mode.

3. The video signal processing apparatus of claim 1,
wherein the video signal is a signal of a video of 720×480 pixels formed by surrounding a periphery of a game video of 480×272 pixels with black pixels.

4. The video signal processing apparatus of claim 1,
wherein the video converter enlargedly displays the area of 480×270 pixels disposed in an almost central portion in the video data to four times (4×) when the predetermined video display mode is a mode to enlargedly display a game video to four times (4×).

5. The video signal processing apparatus of claim 1,
wherein the controller controls a sampling frequency of a horizontal valid period to be 27 MHz (1×) and lines of game video in a vertical direction to be imported with the number thereof unchanged, and controls the video converter to scale the imported video data to four times (4×) both in a horizontal direction and in the vertical direction, when the predetermined video display mode is a mode to enlargedly display a game video to four times (4×).

6. The video signal processing apparatus of claim 1,
wherein the video converter enlargedly displays the area of 640×360 pixels disposed in an almost central portion in the video data to three times (3×) when the predetermined video display mode is a mode to enlargedly display a game video to three times (3×).

7. The video signal processing apparatus of claim 1,
wherein the controller controls a sampling frequency of a horizontal valid period to be 27 MHz (1×) and lines of game video in a vertical direction to be imported with the number thereof unchanged, and controls the video converter to scale the imported video data to three times (3×) both in a horizontal direction and in the vertical direction, when the predetermined video display mode is a mode to enlargedly display a game video to three times (3×).

8. A video signal processing method, comprising:
receiving input of a predetermined video display mode;
controlling, when the input of the predetermined video display mode is received, a sampling frequency and an enlargement ratio of scaling to enlarge the area corresponding to an enlargement scaling factor in video data having almost the same aspect ratio as an aspect ratio of a display panel at a rate of an integral multiple or n/2-times (n is an integer); and
generating video data by sampling a video signal with a predetermined resolution inputted from the outside at the controlled sampling frequency and scaling the area of the generated video data at the controlled enlargement ratio.
